(19) United States
(12) Patent Application Publication
(10) Pub. No.: US 2008/0046363 A1
(43) Pub. Date: Feb. 21, 2008

(54) Automated bill payment

(75) Inventors: Liaqat Ali, Danville, CA (US); Gail Churillo, Fremont, CA (US); Susanne Crockett, Buffalo Grove, IL (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/504,676

(22) Filed: Aug. 16, 2006

(51) Int. Cl. G06Q 40/00

(52) U.S. Cl. 705/40

(57) ABSTRACT

An automated system enables presenting bills and paying bills in a convenient, secure and timely manner. The automated system stores user information in a database, the user information including account information for each user. Based on the user account information, the system generates a bill for services rendered during a predetermined time period. Once the bill has been generated, the system automatically initiates communication with the user through a call generator. Once a communication line has been established, the system may authenticate the user and then provides option information to the user, the option information including at least one of a payment option, a detailed bill information option, and a deferred payment option.

### BACKGROUND OF THE DISCLOSURE

1. Field of the Disclosure

The present disclosure relates generally to automated bill payment, and more particularly to an apparatus, method and computer readable medium for securely and accurately contacting subscribers and receiving bill payment.

2. Background of the Disclosure

Currently, customers have a limited number of options for paying various bills. One of these options includes receiving a bill in the mail, writing a check or money order and mailing a payment to a predetermined address. Another option is to logon to a website over a computer link and pay online using a bank routing number and a user bank account. Yet another option is to have money automatically withdrawn from a bank account.

The first option has been found to be undesirable because it requires reliance on the mail service to timely deliver bills, as well as the respective customer payments. This method is subject to delays due to heavy traffic in mail service, such as during the holidays, and is susceptible to delays due to, for example, inclement weather conditions. The method also requires an added expense to the user for requisite postal fees. Furthermore, when the customer is away from the mailing residence, a “hold” may be placed with the mail service, such as during long vacation periods, or long business trips.

The second option requires access to a computer and the Internet. There remains a large population of customers who do not own a computer, and an even greater population that does not have access to the Internet. However, even for those that have computers and Internet access, security is an issue. For example, identity theft is a problem that many customers are concerned about when transmitting personal information across the Internet, or any other open system that may be improperly exploited.

The third option of automatic withdrawal has also been found to be undesirable. Many customers have found that this option creates two main problems for them. First, it takes the control of payment timing away from the customer, thereby limiting flexibility in payment scheduling. Second, some entities charge a fee for the service, adding additional costs to bill payment.

The present disclosure provides a bill notification and payment method that allows a user to avoid the above problems, while enabling service providers to effectively and efficiently receive bill payments.

### BRIEF DESCRIPTION OF THE DRAWINGS

The present disclosure is further described in the detailed description that follows, by reference to the noted drawings by way of non-limiting examples of embodiments of the present disclosure, in which like reference numerals represent similar parts throughout the several views of the drawings:

FIG. 1 illustrates a generic embodiment of a general computer system, according to an aspect of the present disclosure;

FIG. 2 illustrates an exemplary architecture of an automated bill payment apparatus, according to an aspect of the present disclosure;

FIG. 3 illustrates a flow diagram of an exemplary subscriber contact portion of a bill notification and payment process for performing an aspect of the present disclosure;

FIG. 4 illustrates a flow diagram of an exemplary IVR communication and password confirmation portion of a bill notification and payment process for performing an aspect of the present disclosure; and

FIG. 5 illustrates a flow diagram of an exemplary bill option selection portion of a bill notification and payment process for performing an aspect of the present disclosure.

### DETAILED DESCRIPTION OF THE DISCLOSURE

According to an aspect of the present disclosure, a customer of a service such as, for example, telephone service, cable service or utility service, may subscribe to an automated payment service with the service provider. As part of the sign up process, the customer provides checking, savings, or credit account number information and an authorization that authorizes the service provider to automatically withdraw funds from the account, or charge against the account in the case of credit cards. The customer, as part of the signup process, may be provided a password or some other method of assuring secure access, such as voice identification, to ensure security. This password will be used each time the customer pays a bill. Once an account has been established for the customer in the system, the customer is ready to conveniently pay bills using their telephone.

The disclosed automated bill payment may be used for service industries such as, for example: telephone service, including voice-over-Internet (VOI), cellular or landline service, electric utility service, gas utility service, water utility service, computer network service, medical services, legal services, newswire services, road toll services, or the like. However, the skilled artisan will readily appreciate that any product vendor or service provider may use the automated bill payment system according to an aspect of the disclosure without departing from the spirit or scope of the disclosure.

In view of the above, the present disclosure through one or more of its various aspects and/or embodiments is presented to accomplish one or more objectives and advantages, such as those noted below.

An aspect of the present disclosure provides for an automated bill payment apparatus that includes a bill generator for generating a bill for a user, a call generator for automatically initiating contact with the user, and a communicator for communicating with the user via the call generator. The automated bill payment apparatus includes a database for storing user information, the user information including services rendered for the user and a time period of the services rendered for the user, wherein the bill generator generates the bill based on the user information. The automated bill payment apparatus may further include a monitor for monitoring user activity at a service media, which may include at least one of a telephone service, a cable television service, an Internet service, a satellite broadcast service, a subscription radio signal service, a newswire service, a water supply service, a sewage removal service, a gas service, an electricity service, or a road toll service. The call generator may initiate contact with the user after a predetermined time period elapses after receiving the generated bill, or upon detecting a first occurrence of user activity on the service media after the bill has been generated.

According to a further aspect of the disclosure, the automated bill payment apparatus may include a password authenticator, an account manager, and an option selector. The password authenticator receives a user password from the user through the communicator and authenticates the user password information to generate a password accepted signal. The account manger receives the password accepted signal, retrieves financial account information from the database and authorizes withdrawal from a bank account of the user to pay the bill. The option selector causes the account manager to authorize a withdrawal from the bank account of the user after receiving the password accepted signal.

Once contact has been made between automated bill payment apparatus and the user, the communicator provides option information to the user. The option information may include a payment option, a detailed bill information option, or a deferred payment option. When the user selects the payment option, the communicator provides information regarding the bill to the user and receives authorization to pay the bill. When the user selects the detailed bill information option, the communicator selectively informs the user of current bill status information, including at least one of an amount for local telephone service, long distance service, or wireless service. And, when the user selects the deferred payment option, the communicator selectively informs the user of deferred payment contact information, including at least one of a contact number and a reminder request.

Another aspect of the disclosure provides for a process for automatically paying bills. The process includes generating a bill for a user, automatically initiating communication with the user through a call generator, and providing option information relating to the bill to the user after receiving an authentication signal, which may be a password. In generating the bill for the user, the process retrieves user information, including services rendered for the user, a time period of the services rendered for the user, authentication information for the user, and user subscription information for the user. The process may further include monitoring user activity at a service media, which may include a telephone service, a cable television service, an Internet service, a satellite broadcast service, a subscription radio signal service, a newswire service, a water supply service, a sewage removal service, a gas service, an electricity service, or a road toll service. The process of initiating communication with the user may be based on a predetermined time period elapsing after receiving the generated bill, or upon detecting a first occurrence of user activity on the service media after the bill has been generated.

The process for automatically paying bills, after receiving the authentication signal and accepting the authentication information, generates a password accepted signal. Upon successful completion of authentication, the process communicates a plurality of options to the user for selection, including a payment option, a detailed bill information option, or a deferred payment option. When the user selects the payment option, the process retrieves financial account information from a database and authorizes withdrawal from a bank account of the user to pay the bill. When the user selects the detailed bill information option, the process selectively informs the user of a current bill status information, including at least one of an amount for local telephone service, long distance service, and wireless service. When the user selects the deferred payment option, the process selectively informs the user of a deferred payment contact information, including at least one of a contact telephone number and a reminder request.

Another aspect of the disclosure provides for a computer program tangibly embodied in a computer readable, the computer readable medium including a storing code segment, a generating code segment, a call generating code segment, an authentication code segment, a discriminator code segment, and a reception code segment. The medium may further include a paying code segment. The storing code segment causes user information to be stored in a database, the user information including at least one of account information, services rendered, a time period of the services rendered, and authentication for a user. The generating code segment causes generating a bill for services rendered for the user based on the user account information. The call generating code segment causes automatically generating a call to the user based on the user account information. The authentication code segment causes authenticating the user during the call. The discriminator code segment causes providing option information to the user after the user is authenticated, the option information including at least one of a payment option, a detailed bill information option, and a deferred payment option. The reception code segment for receiving option selection information from the user. The paying code segment may direct payment of the bill in response to the reception code segment receiving option selection information selecting the payment option.

The various aspects and embodiments of the present disclosure are described in detail below.

In the following description of the illustrated embodiments, references are made to the accompanying drawings, which form a part hereof, and in which is shown by way of illustration, various embodiments in which the disclosure may be practiced. It is to be understood that other embodiments may be utilized, and structural and functional changes may be made without departing from the scope and spirit of the present disclosure.

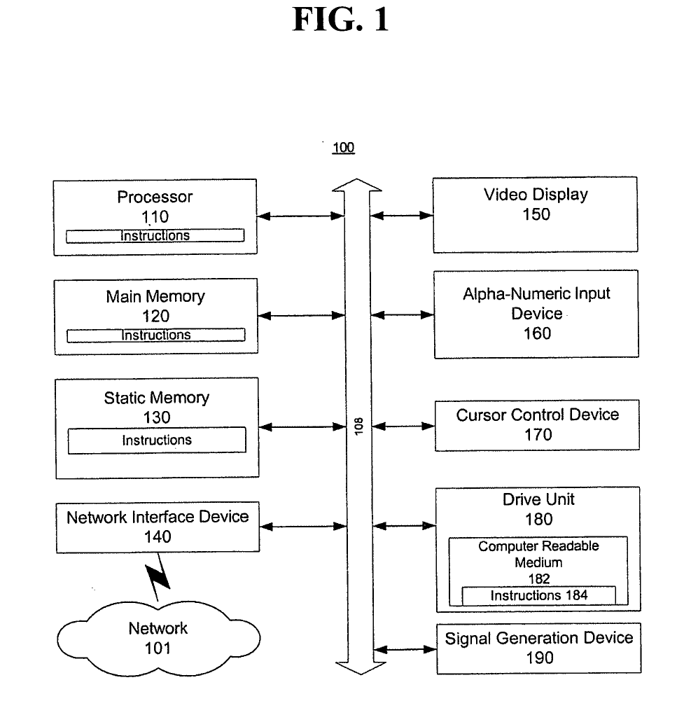

Referring to FIG. 1, a description is now provided of an illustrative embodiment of a general computer system 100, on which the automated bill payment process can be implemented. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Using a general computer system as shown in FIG. 1, a process for automated bill payment may be provided. The system of FIG. 1 can also operate as various elements within the system. For example, a program implementing the disclosure may be loaded and executed on one or more computers.

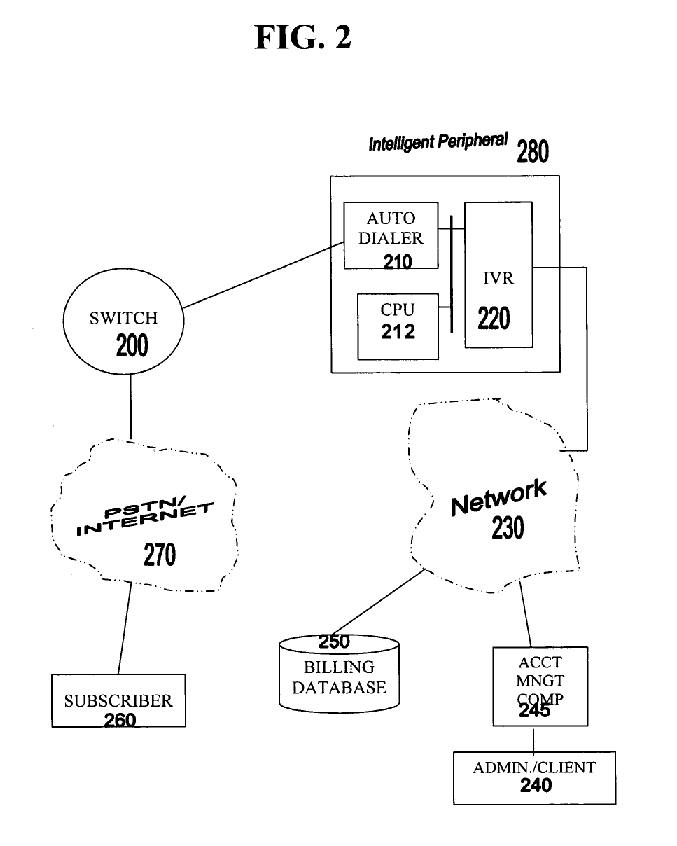

Referring to FIG. 2, an exemplary system and apparatus for carrying out an aspect of the disclosure will be described. As illustrated in the figure, individual subscribers or customers, including the depicted subscriber terminal 260, are linked to a Public Switched Telephone Network (PSTN) 270 or any other communications network. The subscriber terminal 260 may be a conventional touch tone telephone, for example. In alternative embodiments, the subscriber terminal 260 may be an IP telephone, a personal computer or other device capable of communicating using IP protocol, in which case the telecommunications network may include the Internet. The communication links between the subscriber terminal 260 and PSTN 270 may be cable or wire, such as, for example, existing telephone lines or fiber optic lines, using conventional switches and the like. Alternatively, the links may be wireless, such as, for example, radio frequency (RF) signaling as used in wireless telephone, satellite, radio or television communication mediums, or the like.

The PSTN 270 connects the exemplary subscriber terminal 260 to an Intelligent Peripheral (IP) 280, which includes a bus, an auto dialer 210, an interactive voice response (IVR) platform 220, and a central processing unit (CPU) 212, for example, through at least one service switching point 200. The IP 280 is connected to an Account Management Computer (AMC) 245 and a billing database 250 over a network 230. The AMC 245 is also connected to an Administrator, for example, through a client 240. The exemplary AMC 245 and the client 240 are generally of the type shown in FIG. 1, and discussed above with reference to the figure. The network 230 may be any data communication network, such as a local area network, wide area network, the public Internet, an array of networks, or the like, as the skilled artisan will readily appreciate without departing from the spirit or scope of the invention. The system also includes the billing database 250, which contains customer billing information.

The exemplary database 250 contains customer records including, for example, name, address, bank account numbers and bank routing numbers, credit card numbers, line items for each type of service provided (such as, DSL, long distance telephone service, local telephone service, cable television service, dish network service, electricity, gas, water, sewage disposal, etc.), as well as a number of predetermined fields to be used for record management and retrieval, such as specific flags indicating whether the customer has subscribed to any of a number of service plans. In an embodiment, a flag is provided for each customer that subscribes to the automated bill payment system. Although the exemplary database 250 is depicted as a separate device in FIG. 2, the database 250 may alternatively reside in the switch 200, the IP 280, ACM 245, or administrator/client device 240 as the skilled artisan will readily appreciate without departing from the spirit or scope of the disclosure. Furthermore, the database 250 may be a single standalone device, embodied in another device such as a network server, a distributed system of databases, or virtual database made up of an array of devices connected over a network.

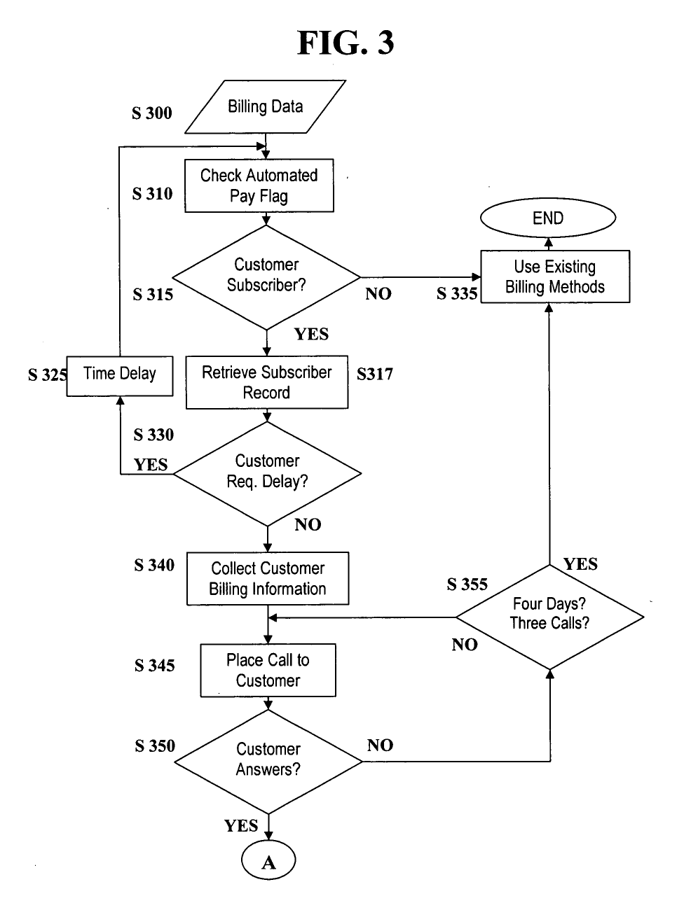

An exemplary description of the interrelationships of the various devices of FIG. 2, as well as the manner in which they function, is discussed below with respect to the exemplary processes depicted in FIGS. 3-5.

Referring to FIG. 3, the process begins once the billing data is available and a bill has been generated at step S300, for example, by the AMC 245. The bill may be generated after a predetermined period of time elapses when the services were incurred, such as a month or three months, for example. The bill may also be generated on the basis of per use, per unit or the like, depending on the system and/or situational needs. For example, water and sewer utility bills may be generated on a quarterly basis, while electric bills are generated on a monthly basis. In contrast, some commercial database vendors, for example, charge based on units of time that the user uses their databases.

The records, in the billing database 250, include a plurality of fields for data such as, for example, name, address, telephone number, subscribed services, billing instructions, etc. One of the services data fields includes data indicating whether a given customer has subscribed to the automated payment service. If the customer has subscribed for automated bill payment, then the customer record will also include a time delay field, which indicates whether a customer has requested that the bill collection process be delayed by a specific time period such as, N days (where N is an integer greater than, or equal to 0). The delay field may alternatively include specific times at which a customer would prefer to be contacted, as well as the preferred medium of contact (such as, for example, email, telephone, instant messaging, or any other electronic form of automated contact).

In an embodiment of the disclosure, the data in the billing database 250 is processed daily in batch form, and the processed batch data is sorted between customers that have subscribed to the automated payment service and customers that have not subscribed to the service based on the information in on a subscriber services field in the record. That is, at step S310 each record is checked to determine if an automated pay flag exists in the above noted field. At step S315, based on whether an automated payment service flag is set in the above field, a determination is made whether the subscriber to the record undergoing processing has subscribed for the automated billing service.

For customers that have not subscribed to the service (step S315; NO), the AMC 245 initializes existing billing methods at step S335 to bill the subscribers for the rendered services—using existing billing methods such as, for example, billing mail service, online collection, or automatic draft. Upon completing the initializing step S335, the process ends.

For customers that have subscribed for the automated payment service (step S315; YES), information, including identifying information and relevant billing information, is retrieved from the billing database 250 at step S317, for example, under control of the AMC 245, and forwarded to the IP 280. However, at step S330, a determination is made whether the subscriber has set a specific time delay that must elapse from the time the bill is generated to the time that the subscriber may be contacted, based on the time delay field in the record being processed. When the subscriber has requested a delay (step S330; YES), the length of the delay is determined at step S325. The corresponding record will be replaced into the database 250 for batch processing at a later time corresponding to a batch processing time that is nearest to the time delay selected by the subscriber. For example, if the subscriber selected a time delay of three days, upon generation of a bill at step S300, the bill will replaced into the database 250 with instructions to resubmit it, via AMC 245, three days from its generation. The skilled artisan will readily appreciate that, instead of batch processing as described above, the billing data may be processed ad hoc, or it may be processed at set times during each day, or any other methodology that the skilled artisan will determine to be necessary based on implementation and resources without departing from the spirit or scope of the disclosure.

When it is determined that there is no subscriber requested delay, or the subscriber requested delay period after generation of the bill has passed (step S330; NO), then the AMC 245 initializes billing information collection and processing at step S340. At step S340, AMC 245 executes a subroutine to collect the account specific information, including the subscriber's telephone number (e.g., associated with the subscriber terminal 260) and a total amount due, for example, from the billing database 250. The total amount due may include government fees, third party fees, equipment rental fees and the like. In an exemplary embodiment, the AMC 245 collects addition subscriber specific data from the billing database 250, such as specific service instances, date and time at which the services were provided, the length (e.g., hours, minutes, and seconds) of each service instance and the nature of each service instance (e.g., telephone call, cellular telephone call, voice-over-internet call, etc.), and all parties involved in the service instance (e.g., sending party, receiving party, monitoring party, etc.). The AMC 245 may then calculate the total amount due based on the collected data. The collected account specific information and telephone number that is associated with the account are then forwarded to the IP 280 through the network 230.

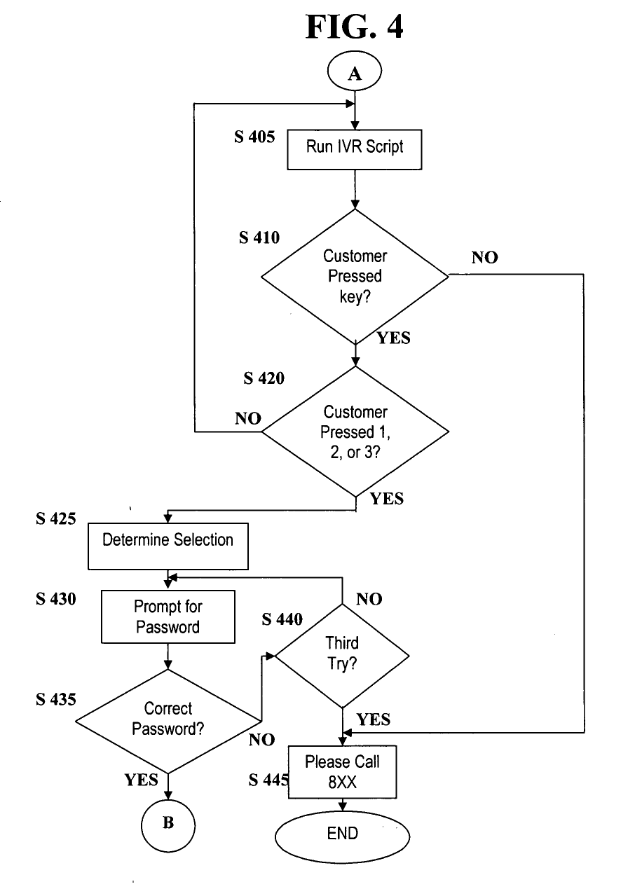

At step S345, the IP 280, having received the collected account specific information and the subscriber telephone number at step S340, executes a subroutine to contact the subscriber via the auto dialer 210 and the IVR 220. In particular, the auto dialer 210 dials the telephone number of the subscriber terminal 260 provided by the AMC 245. At step S350, it is determined whether the subscriber answers the telephone. If the subscriber does not answer the telephone after a predetermined number of “rings” or after a predetermined time elapses (step S350; NO), the AMC 245, or the auto dialer 210, places the record, including all of the billing information, in a queue to retry at a later time. The AMC 245, or the auto dialer 210, will attempt to contact the subscriber, for example, three times per day at predetermined intervals during a predetermined schedule. For example, the subscriber call routine at step S345 may be repeated once at 8:00 AM, once at 7:00 PM and once at 8:00 PM when the subscriber is likely to be at home to answer the telephone, or at times that the subscriber has requested in the initial setup. In the exemplary embodiment, at step S355, when the system is unable to reach the subscriber after four days of calling the subscriber three times per day, the process proceeds to step S335 and initializes billing through existing methods as described above and ends the automated bill payment program. The skilled artisan will readily recognize that the disclosure is not limited to any number of calls per day, number of days, or times of day. Any scheduling interval and/or duration may be used without departing from the spirit or scope of the invention. When the subscriber answers the call from the auto dialer 210 at step S350 (step S350; YES), the call is connected and the process proceeds as shown in FIG. 4.

According to an aspect of the disclosure, instead of automatically placing a call to a subscriber at step S345, the IP 280 may stay in a standby mode until subscriber activity, for example, on a telephone or other terminal device is detected based on monitoring. Upon detecting a first occurrence of subscriber activity on the device, the IP 280 will execute step S345 to contact the subscriber, either immediately or after a predetermined delay. The monitoring of user activity may be performed by configuring the IP 280 to include a monitoring device (not shown) that will “listen” for subscriber activity at the subscriber terminal 260.

However, as discussed above, it is envisioned that other devices may be used instead of a telephone device, such as, for example, a computer device. When a computer device is used for the subscriber terminal 260, the monitoring may be performed by the CPU 212, for example, by transmitting executable code to the subscriber terminal 260 and causing the code to be embedded in the subscriber computer. The embedded code will monitor user activity on the subscriber terminal 260 and communicate detection of predetermined types of subscriber activity on the subscriber computer to the CPU 212. Upon determining a first activity on subscriber terminal 260 after the IP 280 has completed execution of step S340, the code embedded in the subscriber computer will cause a signal to be transmitted to the CPU 212. The CPU 212 will then initialize contacting the subscriber (S345).

Referring to FIG. 4, upon connection by the auto dialer 210 to the subscriber at step S350, the IP 280 executes an IVR script through the IVR 220 at step S405. At step S405, using an interface communication device such as, for example, a voice synthesizer, prerecorded message, visual message, or the like, the IVR 220 provides a message to the subscriber terminal 260 identifying the service provider and the amount of the bill, and offering various options for the subscriber to respond. For example, the IVR 220 may announce the following exemplary message:
“This is an automated voice call from Company Z. Your total bill for the month of January 2006 is $137.26. If you would like to pay your bill now please press 1, to know more details about your bill, please press 2, if you want to pay your bill later, please press 3 for more options”

In the depicted embodiment, at step S410, the IP 280 (or the IVR 220) “listens” for a keypad selection by the subscriber at subscriber terminal 260. If no selection is made by the subscriber for a predetermined period of time, then the IVR 220 initializes and executes step S445, and instructs the subscriber to call a predetermined telephone number, such as, a toll free number, e.g., having a prefix “800” or “888”, to speak to a customer service representative. Upon completing the instructional message to the subscriber, the process ends.

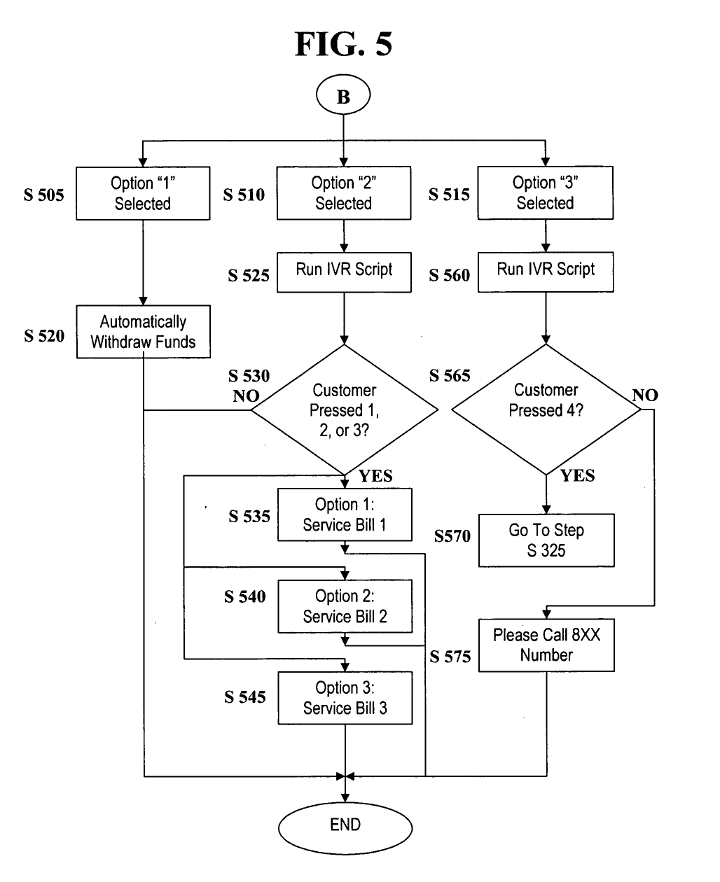

If the subscriber presses a key, then the IVR 220 determines at step S420 whether the subscriber has selected, for example, “1”, “2” or “3”. If the subscriber has selected a key other than one corresponding to “1”, “2” or “3”, then the IVR script is reinitialized by the IVR 220 at step S405. However, if the subscriber has pressed an associated key with one of “1”, “2”, or “3”, then a determination is made at step S425 as to which specific selection was made and the determination of the selection determines further processing, as will be discussed with respect to FIG. 5 below.

When it is determined at step S425 that the subscriber has pressed an associated key for “1”, “2”, or “3”, the process proceeds to step S430. Of course, the selection may be prompted and received in any alternative manner of automated communications. For example, the IVR 220 may be configured to receive and recognize voice response in addition to or instead of touch tones. Also, in the event the subscriber terminal 260 is a personal computer or some other form of graphical user interface, the IP 280 may communicate the various options to the subscriber terminal 260 via text and/or web pages.

At step S430, the subscriber will be prompted to enter the password, or provide some other form of authentication, such as voice recognition. When the subscriber enters the correct password (step S435; YES) (e.g., the password associated with the specific account and/or subscriber telephone number), the process executed by, for example, IP 280 proceeds to one of steps S505, S510, or S515 at FIG. 5, depending on the determination of subscriber selection made at step S425.

If the subscriber enters an incorrect password (step S435; NO), the process will proceed to step S440. At step S440 a determination is made whether the most recent password entry attempt by the subscriber is a third consecutive incorrect attempt. If it is determined that the subscriber has incorrectly entered the password three consecutive times (step S440; YES), step S445 will be initialized by the IP 280 and the subscriber will be instructed to call a toll free telephone number, such as a “800” or “888” telephone number, and the process ends. If it is determined by the IP 280 that the third attempt has not yet been made by the subscriber (step S440; NO), then step S430 will be executed and the subscriber will again be prompted for a password.

Referring to FIG. 5, if the subscriber entered the correct password at step S435, then the process proceeds to one of steps S505, S510, or S515, depending on the determination of subscriber selection made at step S425 by the IP 280. Particularly, if it is determined that the subscriber selected “1” at step S425, then the process executes step S505; if it is determined that the subscriber selected “2” at step S425, then the process executes step S510; and if it is determined that the subscriber selected “3” at step S425, then the process executes step S515.

At step S505, the IP 280 initializes a process to automatically withdraw funds from a subscriber bank account. After the subscriber is informed of the total amount due, step S520 is executed, causing an automatic withdrawal of an amount due (the total amount due for services for the billing period for the bill data collected at step S300), from the subscriber's bank account, such as, for example, checking account, for which the subscriber previously provided information. In alternative embodiments, the payment may be made by automatically charging a credit account number, as discussed above. The payment account information may be stored in the billing database 250 in association with the subscriber's automated bill payment account. In an embodiment, the AMC 245 automatically withdraws funds from the subscriber's bank account and credits the funds to Company Y's designated bill collection account. The AMC 245 then updates the billing database 250 with the updated information and the process ends.

At step S510, where it was determined that the subscriber pressed an associated key for “2” (S425), the IP 280 initializes detailed billing of the subscriber. The process then executes step S525, causing the IVR 220 to retrieve details about the bill and prompt the subscriber, e.g., via the communications interface, to select one of three further options, such as, for example, local telephone bill amount, long distance telephone bill amount, wireless telephone bill amount, or the like. At step S530, the IP 280 determines whether the subscriber has selected one of the options by pressing a key associated with, for example, “1”, “2”, or “3”. If the subscriber presses a key other than one corresponding to one of the three selections, or a predetermined time elapses with no subscriber activity (step S530; NO), then the process ends. However, if the subscriber selects one of the three options at step S530 (step S530; YES), the process proceeds to steps S535, S540, or S545, depending on the subscriber selection.

If the subscriber selected an option corresponding to “1”, then a local telephone service detailed billing process is initialized at step S535 to announce to the subscriber the amount, for example, of the subscriber's local telephone bill and prompt the subscriber whether the subscriber wishes the bill amount for the local service to be automatically paid. If the subscriber elects to pay it automatically, then the amount due for local service is automatically withdrawn from the subscriber's bank account (not pictured). If the subscriber elects not to pay it via automated withdrawal, then the process ends.

If the subscriber selected an option corresponding to “2”, then a long distance telephone billing process is initialized at step S540 to announce to the subscriber the amount, for example, of the subscriber's long distance telephone bill, and prompt the subscriber whether the subscriber wishes the bill amount for the long distance service to be automatically paid. If the subscriber elects to pay it automatically, then the amount due for long distance service is automatically withdrawn from the subscriber's bank account (not pictured). If the subscriber elects not to pay via automated withdrawal, then the process ends.

If the subscriber selected an option corresponding to “3”, then a long cellular telephone billing process is initialized at step S545 to announce to the subscriber the amount, for example, of the subscriber's cellular telephone bill, and prompt the subscriber whether the subscriber wishes the bill amount for the cellular service to be automatically paid. If the subscriber elects to pay it automatically, then the amount due for cellular service is automatically withdrawn from the subscriber's bank account (not pictured). If the subscriber elects not to pay it via automated withdrawal, then the process ends.

If it was determined at step S425 that the subscriber selected an option corresponding to option “3” to pay the bill at a later time, the process proceeds to step S515, and the process for deferred, or delayed, automated bill payment is initialized. The IP 280 executes step S560 to run an IVR script and prompt the subscriber, e.g., via the communications interface, to press a key corresponding to “4” to select deferred automated payment. If the subscriber selects “4” (step S565; YES), then the IP 280 executes step S325 of FIG. 3, enabling the subscriber to enter a specific delay period for billing. If the subscriber requests deferred payment, the relevant information, including the corresponding subscriber account information, is sent to the AMC 245 with instructions to retry in x days (S325), as discussed above. The sent information, including detailed billing information, is caused to be stored in billing database 250, for later retrieval and billing according to the delayed billing process described above.

If, at step S565, the subscriber presses a key other than one corresponding to “4” (step S565; NO), or a predetermined period of time elapses, then the IP 280 executes the process of step S575, where the IVR 220 is caused to instruct the subscriber to call an assigned telephone number to pay the bill at a later time, such as an “800” or “888” telephone number. Upon completing the announcement at step S575, the process ends.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope and spirit of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments that fall within the true spirit and scope of the present disclosure. Thus, to the maximum extent allowed by law, the scope of the invention is to be determined by the broadest permissible interpretation of the following claims and their equivalents, and shall not be restricted or limited by the foregoing detailed description.

Although several exemplary embodiments have been described, it is understood that the words that have been used are words of description and illustration, rather than words of limitation. Changes may be made within the purview of the appended claims, as presently stated and as amended, without departing from the scope and spirit of the invention in its aspects. Although the description refers to particular means, materials and embodiments, the invention is not intended to be limited to the particulars disclosed, but rather extends to all functionally equivalent structures, methods, and uses such as are within the scope of the appended claims.

What is claimed:

1. An automated bill payment apparatus comprising:
a bill generator for generating a bill for a user;
a call generator for automatically initiating contact with the user; and
a communicator for communicating with the user via the call generator, the communicator providing option information to the user, the option information including at least a payment option wherein, when the payment option is selected, the communicator provides information regarding the bill to the user and receives authorization to pay the bill.

2. The automated bill payment apparatus according to claim 1, further comprising:
a database for storing user information, the user information comprising services rendered for the user and a time period of the services rendered for the user, wherein the bill generator generates the bill based on the user information.

3. The automated bill payment apparatus according to claim 1, wherein the call generator initiates contact with the user after a predetermined time period elapses after receiving the generated bill.

4. The automated bill payment apparatus according to claim 1, further comprising:
a monitor for monitoring user activity, wherein the monitor detects a first usage of a service media by the user.

5. The automated bill payment apparatus according to claim 2, the option information further including a detailed bill information option, wherein the communication selectively informs the user of current bill status information when the detailed bill information option is selected, the current bill status information comprising at least one of an amount for local telephone service, long distance service, and wireless service.

6. The automated bill payment apparatus according to claim 1, the option information further including a detailed bill information option, wherein the communication selectively informing the user of deferred payment contact information when a deferred payment option is selected, the deferred payment contact information comprising at least one of a contact number and a reminder request.

7. The automated bill payment apparatus according to claim 4, wherein the first usage comprises a first occurrence of user activity on the service media after the bill has been generated, and wherein the call generator initiates contact with the user upon detection of the first occurrence of user activity

8. The automated bill payment apparatus according to claim 1, further comprising:
a password authenticator for receiving a user password from the user through the communicator and authenticating the user password information to generate a password accepted signal; and
an account manger for receiving the password accepted signal, retrieving financial account information from the database and authorizing withdrawal from a bank account of the user to pay the bill.

9. The automated bill payment apparatus according to claim 8, further comprising:
an option selector for causing the account manager to authorize withdrawal from the bank account of the user after receiving the password accepted signal.

10. The automated bill payment apparatus according to claim 3, wherein the service media comprise one of a telephone service, a cable television service, an Internet service, a satellite broadcast service, a subscription radio signal service, a newswire service, a water supply service, a sewage removal service, a gas service, an electricity service, or a road toll service.

11. A method of automatically paying bills, the method comprising:
generating a bill for a user;
automatically initiating communication with the user through a call generator;
providing option information relating to the bill to the user after receiving an authentication signal, the option information including at least one of a payment option, a detailed bill information option, and a deferred payment option; and
receiving option selection information from the user.

12. The method according to claim 11, the initiating communication with the user comprising contacting the user after a predetermined time period elapses generating the bill.

13. The method according to claim 11, the authentication signal being based on a user password.

14. The method according to claim 11, further comprising:
monitoring user activity to detect a first user usage of a service media.

15. The method according to claim 11, further comprising:
retrieving financial account information from a database and authorizing withdrawal from a bank account of the user.

16. The method according to claim 11, further comprising:
retrieving user information, wherein the user information includes services rendered for the user, a time period of the services rendered for the user, authentication information for the user, and user subscription information for the user.

17. The method according to claim 11, further comprising selectively informing the user of a current bill status information when a detailed bill information option selection is received, wherein the current bill status information includes at least one of an amount for local telephone service, long distance service, and wireless service.

18. The method according to claim 11, further comprising selectively informing the user of a deferred payment contact information when a deferred payment option selection is received, wherein the deferred contact information includes at least one of a contact telephone number and a reminder request.

19. A computer program tangibly embodied in a computer readable, the computer readable medium comprising:
a storing code segment that causes user information to be stored in a database, the user information including at least one of account information, services rendered, a time period of the services rendered, and authentication for a user;
a generating code segment for generating a bill for services rendered for the user based on the user account information;
a call generating code segment for automatically generating a call to the user based on the user account information;
an authentication code segment for authenticating the user during the call;
a discriminator code segment for providing option information to the user after the user is authenticated, the option information including at least one of a payment option, a detailed bill information option, and a deferred payment option; and
a reception code segment for receiving option selection information from the user.

20. The computer readable medium according to claim 19, further comprising:
a paying code segment that directs payment of the bill in response to the reception code segment receiving option selection information selecting the payment option.
